(19) United States
(12) Patent Application Publication
(10) Pub. No.: US 2024/0202775 A1
(43) Pub. Date: Jun. 20, 2024

(54) INFORMATION PROCESSING DEVICE AND INFORMATION PROCESSING METHOD

(71) Applicant: Toshiba Tec Kabushiki Kaisha, Tokyo (JP)

(72) Inventor: Nobuyuki MARUMO, Izu Shizuoka (JP)

(21) Appl. No.: 18/466,558

(22) Filed: Sep. 13, 2023

(30) Foreign Application Priority Data
Dec. 14, 2022 (JP) 2022-199771

(51) Int. Cl. G06Q 30/0251

(52) U.S. Cl. CPC G06Q 30/0255

(57) ABSTRACT

In an embodiment, an information processing device and a program capable of performing purchase support and sales promotion support of a merchandise to be sold in a store are described. An information processing device includes an extraction unit configured to extract a previous visit date from a use history of a customer who visits a store. An identification unit of the device configured to identify, based on relationship information indicating a temporal relationship between a plurality of areas for arranging products provided in the store and sales modes of the products arranged in the areas, those areas for which the merchandise whose sales mode has changed from a previous visit date to a current visit are arranged. An output unit of the device is configured to output information indicating the arrangement area or areas identified by the identification unit.

### CROSS-REFERENCE TO RELATED APPLICATION

This application is based upon and claims the benefit of priority from Japanese Patent Application No. 2022-199771, filed Dec. 14, 2022, the entire contents of which are incorporated herein by reference.

### FIELD

Embodiments described herein relate generally to an information processing device and an information processing method.

### BACKGROUND

A consumer (or customer) who frequents a store such as a supermarket often uses the same store regularly, and thus often knows what items are placed where in the store. The customer may often use certain areas in particular and may tend to visit these same areas either intentionally or by mere habit.

In the related art, a technique is proposed in which, once a predetermined number of days or time elapses from a previous purchase date of a particular item of merchandise, as noted based on merchandise information registered in a purchase history of a customer, merchandise information of another item of merchandise of the same type can be provided to a customer terminal as a prompt for another purchase.

The customer often purchases favorite items regularly. However, the customer may check for and purchase items that were not available at the time of a previous visit, or new items not released or otherwise available until now. The customer may prefer or enjoy shopping for new types of merchandise.

However, the only way for the customer to know which merchandise has been updated since a previous visit is to check with his own eyes. Thus, there are cases in which the customer passes through an area without discovering the new or updated merchandise or does not pass through the area in which the new or updated merchandise is located, which may result in the loss of an opportunity to purchase additional merchandise.

### BRIEF DESCRIPTION OF THE DRAWINGS

FIG. 1 is a diagram schematically showing a purchase support system according to an embodiment.

FIG. 2 is a diagram of a customer terminal.

FIG. 3 is a diagram of a server device.

FIG. 4 is a diagram showing an example of a data configuration of a merchandise master.

FIG. 5 is a diagram showing an example of a data configuration of an arrangement variation file.

FIG. 6 is a diagram showing an example of a data configuration of a customer master.

FIG. 7 is a diagram showing an example of a data configuration of a purchase history file.

FIG. 8 is a diagram depicting functional aspects of a customer terminal and a server device.

FIG. 9 is a diagram showing an example of a purchase support screen.

FIG. 10 is a diagram showing another example of a purchase support screen.

FIG. 11 is a flowchart of a process executed by a customer terminal and a server device.

FIG. 12 is a diagram showing an example of a data configuration of a price variation file according to a first modification.

FIG. 13 is a diagram showing an example of a purchase support screen.

### DETAILED DESCRIPTION

In general, according to one embodiment, provided are an information processing device and an information processing method providing a technological solution improving purchase support and sales promotion support systems for items of merchandise sold in a store.

An information processing device according to an embodiment includes an extraction unit, an identification unit, and an output unit. The extraction unit extracts a previous visit date from a use history of a customer who visits a store. The identification unit identifies, based on relationship information indicating a temporal relationship between a plurality of arrangement areas for products provided in the store and sales modes of the products arranged in the areas, the area in which merchandise whose sales mode has changed from the previous visit date to a current visit date is arranged. The output unit outputs information indicating an arrangement area identified by the identification unit.

Hereinafter, an information processing device and a program according to certain example embodiments will be described with reference to the drawings. The described example embodiment is applied to a store such as a supermarket, but the present disclosure is not limited thereto.

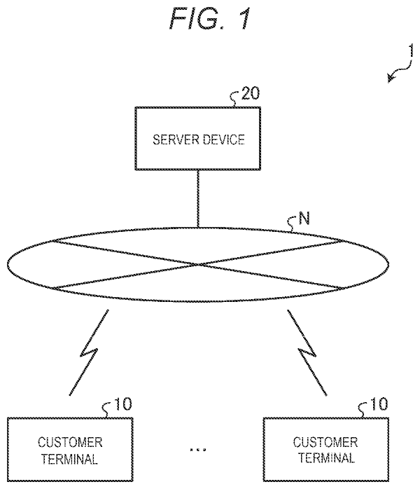

FIG. 1 is a diagram schematically showing a purchase support system 1 according to an embodiment. As shown in FIG. 1, a purchase support system 1 includes customer terminals 10 and a server device 20. The customer terminals 10 and the server device 20 are communicably connected to each other via a network N. The network N is a network such as a local area network (LAN). The network N is formed by, for example, various network devices such as access points provided in the store.

The customer terminal 10 is a terminal device that is operated by a customer. For example, the customer terminal 10 may be a portable terminal device (a user-owned terminal) such as a smartphone or a tablet terminal owned by the customer. In some examples, customer terminal 10 may be a portable terminal device which is provided by the store in which the customer is shopping or a terminal device such as a tablet terminal attached to a shopping cart of the store (such store-provided terminals may be referred to as a store terminal).

The customer terminal 10 according to the embodiment is an example of an information processing device. The customer terminal 10 has a function of providing purchase support and promoting the sale of the products sold by the store. In providing this function, the customer terminal 10 cooperates with the server device 20.

The possible functions of the customer terminal 10 are not limited to these specific functions. For example, the customer terminal 10 may also have a function of reading an identification code (a merchandise code) for identifying the type of the associated merchandise. The identification code can be encoded in a code symbol such as a bar code attached to the item of merchandise to be purchased. The customer terminal 10 may also have a function of registering the read merchandise code in the customer terminal 10 or another device (the server device 20 or the like). The customer terminal 10 may also have a settlement function for performing electronic settlement of a registered merchandise.

The server device 20 is a store server or the like provided in the store. The server device 20 stores and manages various kinds of information related to the purchase support system 1, such as information related to the products to be sold in the store, and information related to the customer who uses the store.

For example, the server device 20 stores and manages, in association with the merchandise code of each merchandise, a merchandise name, a price, an arrangement area in the store, and the like. The server device 20 records the presence (entering and exiting) of the customers on a per customer basis, and records and tracks a most recent date when the customer visited (entered) the store. The server device 20 provides the customer terminal 10 with information for purchase support regarding the products sold in the store.

The functions of the server device 20 are not limited to these described functions. For example, the server device 20 may have a function of handling aspects of merchandise registration that may be executed by the customer terminal 10 such as storing and managing the merchandise codes read by the customer terminal 10 in association with the information for identifying the customer terminal 10 (terminal ID) and the information for identifying the customer who operates the customer terminal 10 (a customer code).

In the purchase support system 1, the number of customer terminals 10 connected to the network N is not particularly limited. For example, if the customer terminal 10 is a user-owned terminal, the customer terminal 10 can be connected to the network N by accessing the network N whenever the customer enters the store.

A connection method of connecting the customer terminal 10 that is a user-owned terminal to the network N is not particularly limited, and various methods can be adopted.

For example, the customer terminal 10 may cause a display unit 114 to display, according to an operation of the customer, the information on the customer terminal 10 for the network connection and a connection code symbol including the customer code of the customer. By reading the connection code symbol with a scanner device provided at an entrance of the store or the like, the customer terminal 10 may be connected to the network N. In this case, display of the connection code symbol may be restricted to be executed only if the customer terminal is a at a position determined by a position acquisition function such as GPS or the like to be in or near the store.

In other examples, a code symbol for connecting to the network N may be displayed at the store and the customer terminal 10 may be connected to the network N by a reading of the code symbol with the customer terminal 10.

The connection method may be implemented as a function of a dedicated application program stored in the customer terminal 10.

FIG. 1 shows an example in which the customer terminals 10 and the server device 20 are connected to the network N. Devices connected to the network N are not limited thereto. For example, a sales data processing device such as a POS terminal provided in the store may be connected to the network N. In addition, a store clerk terminal used by a store clerk in the store, various sensor devices, and the like may be connected to the network N.

In an embodiment, an example in which the server device 20 is a single device is described, but embodiments are not limited thereto. For example, the server device may be implemented as a plurality of devices by a technique such as cloud computing.

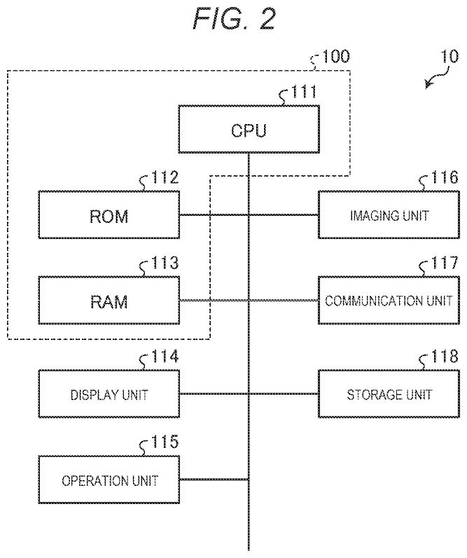

FIG. 2 is a diagram showing an example of a hardware configuration of the customer terminal 10. As shown in FIG. 2, the customer terminal 10 includes a central processing unit (CPU) 111, a read only memory (ROM) 112, and a random access memory (RAM) 113.

The CPU 111 is an example of a processor, and integrally controls units of the customer terminal 10. The ROM 112 stores various programs. The RAM 113 is a work space in which programs and various kinds of data are loaded.

The CPU 111, the ROM 112, and the RAM 113 are connected via a bus or the like, and constitute a control unit 100. In the control unit 100, the CPU 111 operates according to a program stored in a storage unit 118 and loaded in the RAM 113, thereby executing various processes.

The customer terminal 10 includes the display unit 114, an operation unit 115, an imaging unit 116, a communication unit 117, the storage unit 118, and the like.

The display unit 114 is a display device such as a liquid crystal display (LCD). The display unit 114 displays various kinds of information under the control of the CPU 111. For example, the display unit 114 displays various purchase support screens for supporting purchase in the store.

The operation unit 115 is an input device such as a keyboard or a pointing device. The operation unit 115 is operated by the customer and provides user inputs to the CPU 111. The operation unit 115 may be a touch panel provided on a display screen of the display unit 114.

The imaging unit 116 is a digital camera having an imaging element such as a charge coupled device (CCD) or a complementary metal oxide semiconductor (CMOS). In an embodiment, the imaging unit 116 can be used to read (capture an image of) a code symbol such as a bar code or a two-dimensional code, but the embodiment is not limited thereto.

The communication unit 117 is a wireless communication interface that can be connected to the network N. Under the control of the CPU 111, the communication unit 117 is connected to the network N, and transmits and receives various kinds of data to and from the server device 20 or the like connected to the network N.

The storage unit 118 is an auxiliary storage device such as a hard disk drive (HDD) or a solid-state drive (SSD). The storage unit 118 stores various programs (including application programs) executable by the CPU 111 and various kinds of setting information. The storage unit 118 stores various kinds of data related to the display of the purchase support screen. The storage unit 118 stores the customer code of the customer who operates the customer terminal 10.

The hardware configuration of the customer terminal 10 is not limited to the above-described example. For example, the customer terminal 10 may be connectable to another imaging device (a imaging unit 116) without including the imaging unit 116 as internal component or the like. The customer terminal 10 may include a short-range wireless communication unit compatible with a near field communication (NFC) technique.

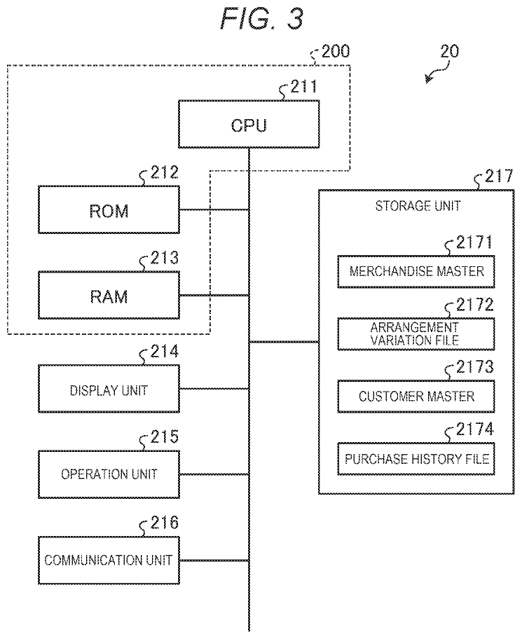

FIG. 3 is a diagram showing an example of a hardware configuration of the server device 20. As shown in FIG. 3, the server device 20 includes a CPU 211, a ROM 212, and a RAM 213.

The CPU 211 is an example of a processor, and integrally controls units of the server device 20. The ROM 212 stores various programs. The RAM 213 is a work space in which programs and various kinds of data are loaded.

The CPU 211, the ROM 212, and the RAM 213 are connected via a bus or the like, and constitute a control unit 200. In the control unit 200, the CPU 211 operates according to a program stored in a storage unit 217 and loaded in the RAM 213, thereby executing various processes.

The server device 20 includes a display unit 214, an operation unit 215, a communication unit 216, the storage unit 217, and the like.

The display unit 214 is a display device such as the LCD. The display unit 214 displays various kinds of information under the control of the CPU 211. The operation unit 215 is an input device such as a keyboard or a pointing device. The operation unit 215 is operated by an operator such as a store clerk and provides user inputs to the CPU 211. The operation unit 215 may be a touch panel provided on a display screen of the display unit 214.

The communication unit 216 is a wired or wireless communication interface connectable to the network N. Under the control of the CPU 211, the communication unit 216 transmits and receives various kinds of data to and from the customer terminal 10 and the like connected to the network N.

The storage unit 217 is an auxiliary storage device such as the HDD or the SSD. The storage unit 217 stores various programs executable by the CPU 211 and various kinds of setting information. The storage unit 217 stores a merchandise master 2171, an arrangement variation file 2172, a customer master 2173, a purchase history file 2174, and the like.

The merchandise master 2171 is a master file that stores merchandise information related to the products sold in the store. The merchandise master 2171 stores information such as a merchandise name of the products sold in the store, a current price, and an arrangement area in which the products are arranged.

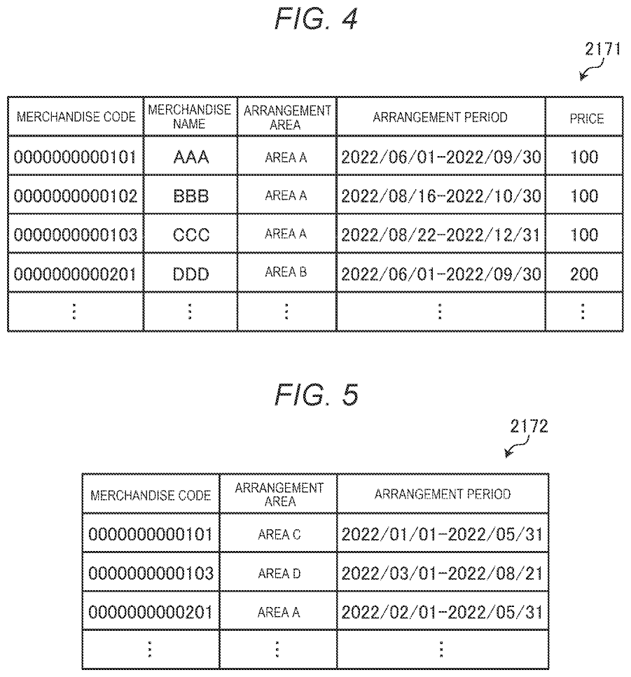

FIG. 4 is a diagram showing an example of a data configuration of the merchandise master 2171. As shown in FIG. 4, the merchandise master 2171 stores, in association with a merchandise code of each item of merchandise, merchandise information such as a merchandise name, an arrangement area, an arrangement period, and a price.

The merchandise name is information indicating a name of an item of merchandise corresponding to a merchandise code. The arrangement area is information indicating an area in the store in which the item is located. The arrangement period is information indicating a time period for which the item is in the arrangement area. The price is information indicating a current sales price of the item. It is assumed, in this example, that an arrangement period including the current (present) date and the arrangement area is registered together in the merchandise master 2171.

Here, areas in the store will be described. The inside of the store can be divided into a plurality of areas according to some predetermined standard or protocol. An address of the area in which corresponding products are arranged, information indicating a division name, or the like is registered as the arrangement area. The standard for defining the areas is not particularly limited, and can be freely set. For example, the areas in the store may be divided in units of merchandise shelves. In addition, the areas in the store may be classified according to classification, characteristics, sales methods, and the like for the products to be arranged, such as a confectionery section, a vegetable section, and a bargain section.

FIG. 4 shows that a merchandise name AAA is arranged in an area A from 2022 Jun. 1 to 2022 Sep. 30, a merchandise name BBB is arranged in the area A from 2022 Aug. 16 to 2022 Oct. 30, and a merchandise name CCC is arranged in the area A from 2022 Aug. 22 to 2022 Dec. 31. In addition, FIG. 4 shows that a merchandise name DDD is arranged in an area B from 2022 Jun. 1 to 2022 Sep. 30.

The information registered in the merchandise master 2171 provides a temporal relationship between the arrangement areas for the products provided in the store and what products are arranged in the arrangement areas at a present time.

The arrangement variation file 2172 is a file that stores a variation history of the products in the arrangement areas. The arrangement variation file 2172 stores, in association with the merchandise code, information such as the arrangement area and the arrangement period in which the merchandise corresponding to the merchandise code was arranged in the past.

FIG. 5 is a diagram showing an example of a data configuration of the arrangement variation file 2172. As shown in FIG. 5, the arrangement variation file 2172 stores, in association with the merchandise code, the arrangement area and the arrangement period in which the merchandise corresponding to the merchandise code was arranged in the past.

FIG. 5 shows that merchandise with a merchandise code “0000000000101” is arranged in an area C from 2022 Jan. 1 to 2022 May 31. In addition, FIG. 5 shows that merchandise with a merchandise code “0000000000103” is arranged in an area D from 2022 Mar. 1 to 2022 Aug. 21. In addition, FIG. 5 shows that merchandise with a merchandise code “0000000000201” is arranged in the area A from 2022 Feb. 1 to 2022 May 31.

Merchandise with a merchandise code “0000000000102” existing in the merchandise master 2171 in FIG. 4 is not registered in the arrangement variation file 2172 in FIG. 5. That is, the merchandise with the merchandise name BBB registered in the merchandise master 2171 is new merchandise that is newly arranged.

The information stored in the arrangement variation file 2172 provides the temporal relationship between the products arranged in the plurality of arrangement areas and the arrangement areas. That is, the arrangement variation file 2172 provides information about what products were located in which arrangement areas and when.

In the embodiment, the arrangement variation file 2172 stores a past arrangement period and an arrangement area together. The arrangement variation file 2172 may store an arrangement period including the current date and the arrangement area together. In this case, the arrangement period and the arrangement area for each merchandise type is not required to be included in the merchandise master 2171, and the arrangement variation file 2172 may be used to centrally track the past arrangements and the present arrangements for the arrangement areas and products.

The customer master 2173 is a master file that stores customer information related to a customer. The customer master 2173 stores, in association with a customer code identifying the customer, information such as a name, a last visit date, a favorite area, and an entry state of the customer corresponding to the customer code.

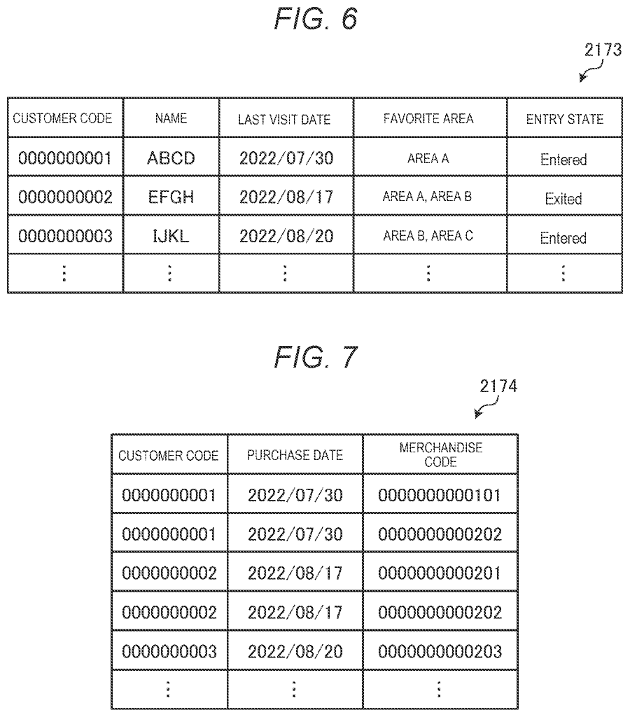

FIG. 6 is a diagram showing an example of a data configuration of the customer master 2173. As shown in FIG. 6, the customer master 2173 stores, in association with the customer code, customer information such as the name, the last visit date, the favorite area, and the entry state of the customer corresponding to the customer code.

The name is information indicating a customer name corresponding to a customer code. The last visit date is information indicating a date when the customer corresponding to the customer code most recently enters the store.

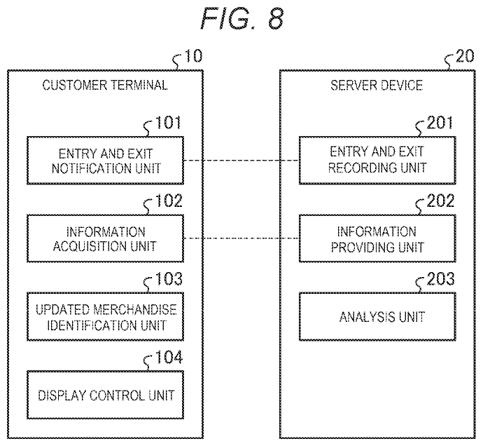

The favorite area is information indicating an area in the store that is frequently used by the customer. The favorite area may be an area set as requested by the customer or may be automatically derived based on a purchase history of the customer. In the embodiment, automatic derivation by an analysis unit 203 (see FIG. 8) is used.

The entry state is information indicating whether the customer corresponding to the customer code has entered the store or exited the store. The entry state is registered (updated) by an entry and exit recording unit 201 (see FIG. 8).

As described above, the customer information stored in the customer master 2173 includes a previous visit date of the customer and an entered or exited state. That is, the customer information is also an example of the use history of the customer who visits the store.

The purchase history file 2174 is a file that stores a purchase history of the products purchased by the customer in the store. The purchase history file 2174 stores, in association with the customer code, a purchase date, a merchandise code, and the like of the products purchased by the customer corresponding to the customer code.

FIG. 7 is a diagram showing an example of a data configuration of the purchase history file 2174. As shown in FIG. 7, the purchase history file 2174 stores, in association with the customer code, the purchase date and the merchandise code of the products purchased by the customer corresponding to the customer code as the purchase history.

The purchase date is information indicating a date when the customer (corresponding to the customer code) purchased the product(s) in the store. The merchandise code is information indicating the merchandise code of the product purchased on the purchase date by the customer.

Registration of purchase history information in the purchase history file 2174 may be performed by the server device 20 or may be performed by another device other than the server device 20. In the former case, for example, the control unit 200 of the server device 20 collects, from POS terminals, transaction information for transactions for which settlement is completed. Then, the server device 20 registers, in the purchase history file 2174, the customer code and the merchandise code included in the transaction information in association with a transaction date (the purchase date).

Next, a functional configuration of the customer terminal 10 and the server device 20 will be described. FIG. 8 is a diagram showing an example of a functional configuration of the customer terminal 10. As shown in FIG. 8, the customer terminal 10 includes, as a functional configuration, an entry and exit notification unit 101, an information acquisition unit 102, an updated merchandise identification unit 103, and a display control unit 104. Specifically, the control unit 100 (e.g., CPU 111) of the customer terminal 10 executes the programs stored in the ROM 112 or the storage unit 118 to implement the above-described functional configuration.

In an embodiment, the functions of the customer terminal 10 are provided by a software configuration implemented by cooperation between the processor and the program of the customer terminal 10, but embodiments are not limited thereto. A part or all of the described functions may be implemented as a hardware configuration such as a dedicated circuit, or the like.

The server device 20 can be considered to include, as a functional configuration, the entry and exit recording unit 201, an information providing unit 202, and the analysis unit 203. Specifically, the control unit 200 (the CPU 211) of the server device 20 executes the programs stored in the ROM 212 or the storage unit 217 to provide the functional configuration.

In an embodiment, the functional aspects of the server device 20 are provided by a software configuration implemented by cooperation between the processor and a program of the server device 20, but an embodiment is not limited thereto. A part or all of the functional aspects may be implemented as a hardware configuration such as a dedicated circuit, or the like.

The entry and exit notification unit 101 of the customer terminal 10 notifies the server device 20 the entering of the store and the exiting of the store. There is no particular limitation on a method of notifying entry and exit, and various methods can be adopted according to specifications of the customer terminal 10 and the store.

For example, if the customer terminal 10 is a user-owned terminal (the customer's own property), the entry and exit notification unit 101 notifies the entry by transmitting, to the server device 20, information indicating the entry together with the customer code of the customer related to the customer terminal 10 when the customer terminal 10 is first connected to the network N. In addition, if an instruction to disconnect from the network N is given from the operation unit 115 or the control unit 100, the entry and exit notification unit 101 of the user-owned terminal notifies exit by transmitting, to the server device 20, information indicating the exit together with the customer code. The entry and exit notification unit 101 may control the connection and disconnection to and from the network N by cooperating with the communication unit 117.

For example, if the customer terminal 10 is a store owned or provided terminal, when a login operation for inputting of the customer code is performed through the operation unit 115 or the like, the entry and exit notification unit 101 notifies the entry by transmitting, to the server device 20, information indicating the entry together with the customer code. When a logout operation is performed through the operation unit 115 or the like, the entry and exit notification unit 101 of the store terminal notifies the exit by transmitting, to the server device 20, information indicating the exit together with the customer code.

For example, if the customer terminal 10 has a merchandise settlement function, the entry and exit notification unit 101 may notify the exit by transmitting, to the server device 20, information indicating the exit together with the customer code when the settlement is completed.

The entry and exit recording unit 201 of the server device 20 records the entering and exiting state of the customer in the customer master 2173 based on the information transmitted from the customer terminal 10 or the devices in the store.

For example, upon receiving an entry notification from the customer terminal 10, the entry and exit recording unit 201 detects that the customer corresponding to the customer code instructed by the entry notification enters the store. If the entry and exit recording unit 201 detects the entry of the customer, the entry and exit recording unit 201 updates the entry state included in the customer information of the customer to “entered”.

In addition, upon receiving an exit notification from the customer terminal 10, the entry and exit recording unit 201 detects that the customer exits the store. If the entry and exit recording unit 201 detects the exit of the customer, the entry and exit recording unit 201 updates the entry state included in the customer information of the customer to “exited”. The entry and exit recording unit 201 registers (overwrites) the date when the exit is detected as the last visit date included in the customer information. That is, until the customer exits the store, the date of the previous entry is held as the last visit date of the customer master 2173.

In the embodiment, the entry notification and the exit notification are transmitted by the customer terminal 10, but may be transmitted from a device other than the customer terminal 10. For example, the entry and exit recording unit 201 may receive the entry notification from a scanner device that reads the connection code symbol. The entry and exit recording unit 201 may receive the exit notification from the POS terminal of the store. If a customer terminal 10 disappears from (drops off) the network N, the entry and exit recording unit 201 may determine that the customer corresponding to the customer code exits the store, and update the entry state to “exited”.

The information providing unit 202 of the server device 20 provides various kinds of information to the customer terminal 10 connected to the network N. For example, the information providing unit 202 provides the information registered in the merchandise master 2171, the arrangement variation file 2172, the customer master 2173, and the purchase history file 2174.

The information provided by the information providing unit 202 is not limited to these examples. For example, the information providing unit 202 may provide information particularly related to the display of the purchase support screen. For example, the information providing unit 202 may provide a map of the store or information for a graphical user interface (GUI). The information providing unit 202 may be configured to provide information to the customer terminal 10 whenever the customer code is in the entry state of “entered”.

The information acquisition unit 102 of the customer terminal 10 acquires various kinds of information from the server device 20. For example, the information acquisition unit 102 acquires, based on the customer code, the customer information corresponding to the customer code from the merchandise master 2171.

The updated merchandise identification unit 103 of the customer terminal 10 is an example of an extraction unit and an identification unit. The updated merchandise identification unit 103 extracts the last visit date from the customer information acquired by the information acquisition unit 102. The updated merchandise identification unit 103 identifies, from the merchandise master 2171 or the like, the merchandise (updated merchandise) for which some aspect (e.g., location, price, stocking status) has changed between the previous visit date (last visit date) to the current visit date.

As an example, the updated merchandise identification unit 103 identifies, as an updated product, a product whose arrangement area has changed between the previous visit date to the current visit date. Specifically, the updated merchandise identification unit 103 compares the last visit date with the arrangement period of the products registered in the merchandise master 2171, and identifies the merchandise codes of the items whose arrangement area has been updated after the last visit date. More specifically, the updated merchandise identification unit 103 identifies the merchandise codes of the updated products whose arrangement period is after the date of the last visit date. Here, an updated product, item, or merchandise means a product, item, or merchandise for which the arrangement area was changed after the last visit date or that the product, item, or merchandise was newly added to the store's products for sale after the last visit date.

Then, the updated merchandise identification unit 103 reads, from the merchandise master 2171, the merchandise codes and the merchandise names of the identified updated products and the updated arrangement areas registered in the merchandise master 2171, and generates the merchandise codes, the merchandise names, and the updated arrangement areas as updated merchandise information.

The updated merchandise information may include other information such as a price of the updated merchandise. For example, the updated merchandise identification unit 103 may include the arrangement area before the update. In this case, the updated merchandise identification unit 103 reads the arrangement area at the time of the last visit date before the update from the arrangement variation file 2172. Specifically, the updated merchandise identification unit 103 refers to the arrangement variation file 2172, and reads the arrangement area corresponding to the arrangement period for the last visit date from among the arrangement periods stored in association with the merchandise code of the updated merchandise. Then, the updated merchandise identification unit 103 generates the updated merchandise information including the arrangement area before and after the update.

The updated merchandise identification unit 103 may identify the updated products only in a part of the areas in the store. For example, the updated merchandise identification unit 103 may read the favorite area from the customer information and determine whether the updated merchandise exists in the area set as the favorite area.

In this case, after the updated merchandise identification unit 103 identifies the updated merchandise from the merchandise master 2171, the updated merchandise identification unit 103 may extract the updated merchandise whose arrangement area matches the favorite area. The updated merchandise identification unit 103 may set the products arranged in the favorite area among the products registered in the merchandise master 2171 as a processing target, and identify the updated merchandise from the products as the processing target.

Accordingly, the updated merchandise identification unit 103 can identify the merchandise moved to the favorite area after the last visit date or the new merchandise that is newly arranged in the favorite areas.

In this case, the updated merchandise identification unit 103 may also identify the merchandise moved from the favorite area to another area as the updated merchandise. Specifically, the updated merchandise identification unit 103 refers to the arrangement variation file 2172 and extracts the merchandise arranged in the favorite area at the time of the last visit date, but now moved to another area. The updated merchandise identification unit 103 refers to the merchandise master 2171 and reads the arrangement area of the merchandise codes corresponding to the updated merchandise to find the updated arrangement area. Then, the updated merchandise identification unit 103 generates the updated merchandise information including the arrangement areas before and after the update together with the merchandise code of the updated merchandise.

Accordingly, the updated merchandise identification unit 103 can identify, as the updated merchandise, the merchandise moved to another area at the time of a current entry date, even though the merchandise is arranged in the favorite area at the time of the last visit date, which is the previous entry date.

The display control unit 104 of the customer terminal 10 is an example of an output unit. The display control unit 104 displays various screens on the display unit 114. For example, the display control unit 104 causes the display unit 114 to display a purchase support screen for supporting merchandise purchase in the store based on the updated merchandise information.

As an example, the display control unit 104 causes the display unit 114 to display a purchase support screen in which the arrangement area in which the updated products are arranged can be identified using map information indicating a layout in the store. The map information may be stored in advance in the storage unit 118 or may be provided from the server device 20.

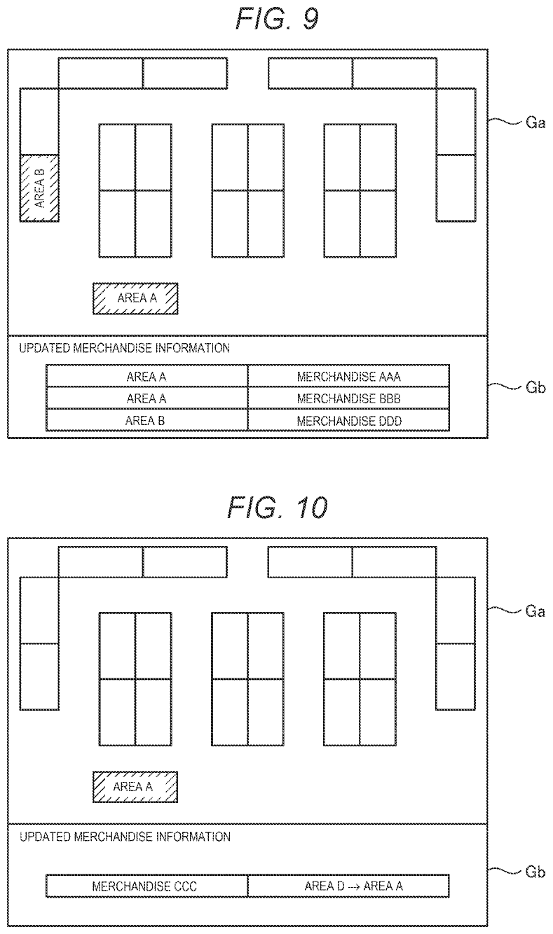

Here, the purchase support screen displayed by the display control unit 104 will be described with reference to FIGS. 9 and 10. FIGS. 9 and 10 are diagrams showing an example of the purchase support screen displayed by the display control unit 104 of the customer terminal 10.

As shown in FIG. 9, the display control unit 104 displays, based on the map information, a map image indicating the layout in the store in a first area Ga. Here, the map image schematically indicates, for example, a positional relationship of areas in the store.

The display control unit 104 displays, based on the updated merchandise information, the updated arrangement areas in which the updated products are arranged and the merchandise names thereof in a second area Gb. FIG. 9 shows an example in which merchandise with the merchandise name AAA and merchandise with the merchandise name BBB are arranged in the area A, and merchandise with the merchandise name DDD is arranged in the area B are these items of merchandise are updated products, and contents thereof are displayed in the second area Gb. Further, on the map image of the first area Ga, areas corresponding to the areas A and B in which the updated products are arranged are highlighted and displayed to be identifiable from areas corresponding to other areas.

By viewing the purchase support screen displayed on the display unit 114, the customer can easily check the arrangement area in which the products that were updated since a previous entry, that is, in this context, the products whose arrangement positions differ from the last visit. Accordingly, the customer can efficiently find the rearranged products or the new products in an arrangement area in which the updated products are arranged. For example, if the updated products are identified by being narrowed down to the favorite area of the customer, by viewing the purchase support screen, the customer can easily check whether there was a rearrangement of the products or the addition of new products in the area frequently used by the customer.

If a position and an orientation of the customer terminal in the store can be identified by the GPS function or the like of the customer terminal 10, the display control unit 104 may display the position and the orientation of the customer terminal on the map image.

FIG. 10 is another example of the purchase support screen. FIG. 10 shows an example of the purchase support screen displayed based on the updated merchandise information including the arrangement area before and after the update. Here, the purchase support screen in FIG. 10 has the first area Ga and the second area Gb as in FIG. 9, whereas information displayed in the second area Gb is different.

Specifically, FIG. 10 shows a case in which merchandise with the merchandise name CCC was arranged in the area D at the time of the previous visit but is now arranged in the area A at the time of the current visit, and a content thereof is displayed in the second area Gb.

Accordingly, the customer who operates the customer terminal 10 can easily check the arrangement area before and after the update of the updated products by viewing the purchase support screen in FIG. 10.

In FIG. 10, similarly to FIG. 9, the updated arrangement area (the area A) is highlighted on the map image, but a display method is not limited thereto. For example, the arrangement areas before and after the update may be connected by an arrow or the like, and the merchandise names of the updated products corresponding to the arrow may be displayed in association with each other, so that the transition of the arrangement areas may be displayed in an identifiable manner.

In the purchase support screen in FIG. 9, the updated arrangement areas in which the updated products are arranged and the merchandise names thereof are displayed in the second area Gb. The merchandise name of the updated merchandise may not be displayed in the second area Gb. For example, depending on the customer, it is sufficient to know the area in which certain kind of change occurs, and it is assumed that certain customers enjoy actually viewing and checking what kind of change occurs. Therefore, information indicating the area may be displayed so that the area with the products updated since the previous entry, that is, the products whose arrangement positions were changed, can be recognized.

In this case, the customer can easily know the area in which the products are rearranged or to which the new products have been added since the previous visit, and can have an experience of actually viewing and checking what kind of change occurs in the area. If the updated products are identified by being narrowed down to the favorite area of the customer, by viewing the purchase support screen, the customer can easily know whether there is any change in the rearrangement of the products or the addition of new products in the area frequently used by the customer, and can have an experience of actually viewing and checking what kind of change occurs in the favorite area of the customer.

Referring back to FIG. 8, the analysis unit 203 of the server device 20 is an example of a derivation unit. The analysis unit 203 derives the area frequently used by the customer as the favorite area by analyzing a behavior of the customer who uses the store.

Specifically, the analysis unit 203 extracts the purchase date and the merchandise code on a per customer code basis which is registered in the purchase history file 2174. Next, the analysis unit 203 identifies, based on the arrangement areas and the arrangement periods of the products registered in the merchandise master 2171 and the arrangement variation file 2172, an arrangement area in which the merchandise corresponding to the merchandise code extracted from the purchase history file 2174 is arranged on the purchase date. The analysis unit 203 derives, on a per customer code basis, an area frequently used by the customer corresponding to the customer code as the favorite area by analyzing an appearance frequency, a ratio of dwell time, or the like of the identified arrangement area. Then, the analysis unit 203 registers the favorite area derived on a per customer code basis in the customer master 2173.

A method of deriving the favorite area is not limited thereto, and any known method may be used. It is also assumed that a timing at which the favorite area is derived is not particularly limited. For example, the analysis unit 203 may derive the favorite area at some predetermined timing or interval, such as every month.

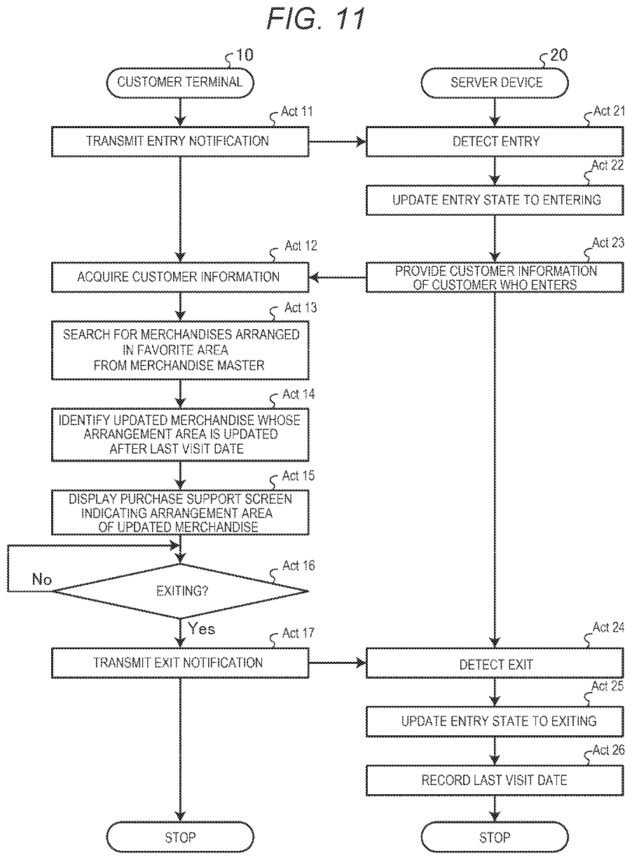

Next, an operation example of the purchase support system 1 will be described. FIG. 11 is a flowchart showing an example of a process executed by the customer terminal 10 and the server device 20.

First, the entry and exit notification unit 101 of the customer terminal 10 cooperates with various devices provided in the store to transmit, to the server device 20, an entry notification including the customer code of the customer who operates the customer terminal 10 (Act 11).

Upon receiving the entry notification from the customer terminal 10, the entry and exit recording unit 201 of the server device 20 detects that the customer corresponding to the customer code instructed by the entry notification enters the store (Act 21). Next, the entry and exit recording unit 201 searches for the customer information of the customer code whose entry is detected from the customer master 2173, and updates the entry state included in the customer information to “entered” (Act 22).

Subsequently, the information providing unit 202 of the server device 20 reads the customer information updated to “entered” in Act 22 from the customer master 2173, and provides the customer information to the customer terminal 10 related to the customer code of the customer information (Act 23).

On the other hand, the information acquisition unit 102 of the customer terminal 10 acquires the customer information provided from the server device 20 (Act 12). The updated merchandise identification unit 103 of the customer terminal 10 refers to the merchandise master 2171 to search for products arranged in the favorite area of the customer (Act 13). Next, the updated merchandise identification unit 103 identifies, based on the last visit date of the customer and the arrangement period and the arrangement area of the searched products, the updated merchandise whose arrangement area is updated after the last visit date and the arrangement area thereof (Act 14).

Subsequently, the display control unit 104 of the customer terminal 10 causes the display unit 114 to display, based on the updated merchandise information that is a processing result in Act 14, the purchase support screen (see FIGS. 9 and 10) indicating the arrangement area of the updated merchandise (Act 15).

The customer who operates the customer terminal 10 can start shopping by moving in the store while viewing the purchase support screen. For example, the customer who uses the customer terminal 10 moves toward the area in which the updated merchandise indicated in the map image is arranged, and can pick up the desired merchandise in the area. Then, the customer uses the customer terminal 10 or the POS terminal to register and settle the picked up merchandise.

Subsequently, the entry and exit notification unit 101 determines whether exiting is instructed (Act 16), and waits until the exiting is instructed (Act 16; No). For example, the entry and exit notification unit 101 determines that the exiting is instructed if an application termination instruction or a disconnection from the network N is instructed (Act 16; Yes). Then, the entry and exit notification unit 101 transmits, to the server device 20, an exit notification including the customer code (Act 17).

On the other hand, upon receiving the exit notification from the customer terminal 10, the entry and exit recording unit 201 of the server device 20 detects that the customer corresponding to the customer code instructed by the exit notification exits the store (Act 24). Next, the entry and exit recording unit 201 searches for the customer information of the customer code whose exit is detected from the customer master 2173, and updates the entry state included in the customer information to “exited” (Act 25). Then, the entry and exit recording unit 201 records today's date as the last visit date in the customer information (Act 26), and ends the process.

As described above, the customer terminal 10 according to the embodiment extracts the last visit date from the customer information, and identifies the area(s) in which the updated merchandise since the last visit date is arranged. The updated merchandise can be identified based the temporal relationship information for the areas and the merchandise (in the merchandise master 2171), Then, the customer terminal 10 outputs information indicating an identified arrangement area through the purchase support screen.

Accordingly, the customer who operates the customer terminal 10 can easily know, through the purchase support screen output by the customer terminal 10, the arrangement area in which updated, rearranged, newly added, or the like products since previous visit date are arranged. Accordingly, the customer can easily check for new merchandise that was not available at the time of the previous visit or merchandise that was moved in to the purchase area indicated by the purchase support screen. Therefore, the customer terminal 10 can support the purchase of products, and can also support the sales promotion of the products.

The above embodiment can be modified and implemented as appropriate by changing a part of the configuration or function of each device described above. Certain modifications of the above embodiment will be described as additional embodiments. In the following, differences from the previously described-embodiment will be mainly described. The described modifications below may be implemented individually or in combination with each other as appropriate.

### FIRST MODIFICATION

In the above-described embodiment, an example is described in which the updated merchandise whose arrangement area has been changed is identified as the updated merchandise since the previous visit date of the customer. In the modification, as another example of the updated merchandise, merchandise whose price has changed since the last visit is identified as the updated merchandise.

The server device 20 according to the modification stores a price variation file 2175 such as shown in FIG. 12 in the storage unit 217 together with the above-described various other files. FIG. 12 is a diagram showing an example of a data configuration of the price variation file 2175. The price variation file 2175 stores, in association with a merchandise code, a past price of the item of merchandise and an applicable period of the price.

FIG. 12 shows that the merchandise with the merchandise code “0000000000101” was sold at 100 yen from 2022 Jan. 1 to 2022 May 31. FIG. 12 shows that the merchandise with the merchandise code “0000000000102” was sold at 120 yen from 2022 Aug. 16 to 2022 Aug. 31. FIG. 12 shows that the merchandise with the merchandise code “0000000000103” was sold at 150 yen from 2022 Jan. 1 to 2022 Aug. 21. FIG. 12 shows that the merchandise with the merchandise code “0000000000201” was sold at 250 yen from 2022 Jan. 1 to 2022 Apr. 30 and at 230 yen from 2022 May 1 to 2022 May 31.

The information registered in the arrangement variation file 2172 is an example of relationship information indicating the temporal relationship for the plurality of arrangement areas for the products provided in the store and the products in the arrangement areas.

The updated merchandise identification unit 103 of the customer terminal 10 according to the modification extracts the last visit date from the customer information acquired by the information acquisition unit 102. Then, the updated merchandise identification unit 103 identifies, from the merchandise master 2171 and the price variation file 2175, the updated merchandise whose price has changed from the previous visit date to the current visit date.

Specifically, the updated merchandise identification unit 103 compares the last visit date included in the customer information with the applicable period of each item of merchandise registered in the price variation file 2175, and identifies the price at the last visit date for each item of merchandise item. Next, the updated merchandise identification unit 103 compares, on a per merchandise item basis, the price identified in the price variation file 2175 with the price currently registered in the merchandise master 2171, and identifies the item(s) whose price is different as the updated merchandise.

Then, the updated merchandise identification unit 103 reads the merchandise code and the merchandise name for the identified updated merchandise, the price before and after the update, and the arrangement area registered in the merchandise master 2171, and generates the merchandise code, the merchandise name, the price before and after the update, and the arrangement area as the updated merchandise information.

The updated merchandise identification unit 103 in some examples may identify the updated merchandise only in some of the areas in the store. For example, the updated merchandise identification unit 103 may read the favorite area from the customer information and identify the updated merchandise for the area set as the favorite area.

In this case, the updated merchandise identification unit 103 may identify the updated merchandise from the price variation file 2175 and the merchandise master 2171 in the above-described procedure, and then extract the updated merchandise in the favorite area. The updated merchandise identification unit 103 may set the products arranged in the favorite area among the products registered in the merchandise master 2171 as a processing target, and identify the updated merchandise from the products as the processing target.

Accordingly, the updated merchandise identification unit 103 can identify, among the products arranged in the favorite area, the items whose price has changed after the last visit date, which is the previous entry date (also referred to as a visit date) as the updated merchandise.

In this case, the updated merchandise identification unit 103 may identify the updated merchandise whose price is changed from among the products moved from the favorite area to another area.

Specifically, the updated merchandise identification unit 103 refers to the arrangement variation file 2172, and searches for the products arranged in the favorite area at the time of the last visit date. Next, the updated merchandise identification unit 103 compares the last visit date and the applicable periods for the merchandise corresponding to the merchandise code of the searched merchandise among the products registered in the price variation file 2175, and identifies the price at the last visit date on a per merchandise item basis. Next, the updated merchandise identification unit 103 compares the price of the merchandise corresponding to the merchandise code of the searched merchandise among the products registered in the merchandise master 2171 with the price of the merchandise identified in the price variation file 2175, and identifies the products whose price is different as the updated merchandise.

Then, the updated merchandise identification unit 103 reads the merchandise code and the merchandise name of the identified updated merchandise, the price before and after the update, and the arrangement area before and after the update, and generates the merchandise code, the merchandise name, the price before and after the update, and the arrangement area as the updated merchandise information.

Accordingly, the updated merchandise identification unit 103 can identify the updated merchandise whose price is changed among the products which are arranged in the favorite area at the time of the last visit date which is the previous entry date and are moved to another area at the time of the current entry date.

The display control unit 104 of the customer terminal 10 according to the modification causes the display unit 114 to display, based on the above-described updated merchandise information, the purchase support screen indicating an arrangement area in which the merchandise whose price is changed since the previous visit is arranged.

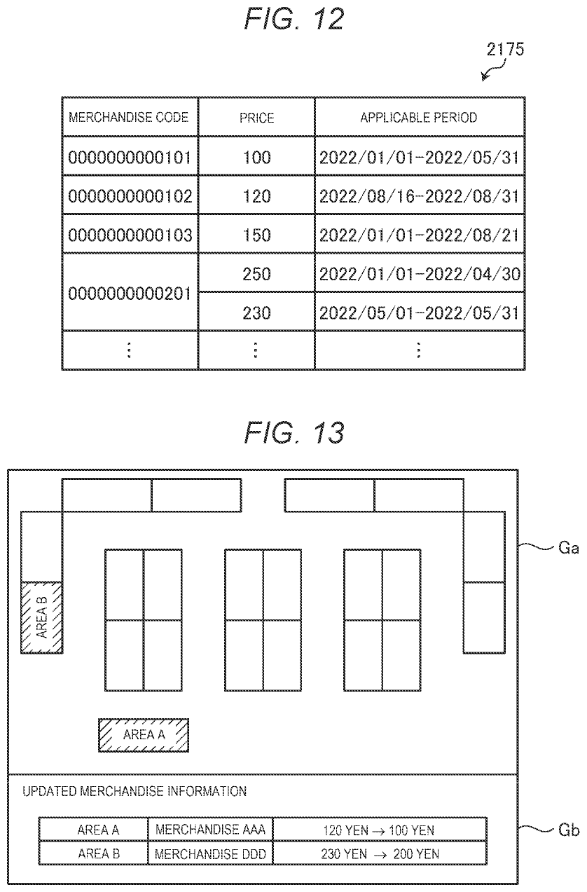

FIG. 13 is a diagram showing an example of the purchase support screen displayed by the display control unit 104 of the customer terminal 10 according to the modification.

As shown in FIG. 13, the display control unit 104 displays a map image in the first area Ga and displays information based on the updated merchandise information in the second area Gb. FIG. 13 shows that the price of the merchandise of the merchandise name AAA arranged in the area A is brought down from 120 yen at the time of the previous entry to 100 yen at the time of the current entry. FIG. 13 shows that the price of the merchandise of the merchandise name DDD arranged in the area B is brought down from 230 yen at the time of the previous entry to 200 yen at the time of the current entry. Further, on the map image of the first area Ga, the area A and the area B in which the updated products are arranged can be highlighted to be distinguished from other areas.

By viewing the purchase support screen displayed on the display unit 114, the customer can easily check the locations of merchandise whose price has changed since the previous visit. Accordingly, the customer can efficiently check and select merchandise in the arrangement area indicated by the purchase support screen as reduced in price or the like.

For example, if the updated products are identified by being narrowed down to the favorite area of the customer, the customer can easily check whether there has been a change in the price in a favorite area frequently used by the customer by viewing the purchase support screen. Accordingly, the customer can efficiently check and select products whose price has been reduced in the favorite area.

### SECOND MODIFICATION

In the above-described embodiment, a last visit date and time is registered when the entry and exit recording unit 201 of the server device 20 detects the exit. However, a method of registering the last visit date and time is not limited thereto.

For example, the control unit 200 or the entry and exit recording unit 201 may extract the latest purchase date from the purchase history file 2174 on a per customer code basis and register the extracted purchase date as the last visit date and time in the customer master 2173. In this case, the purchase history file 2174 corresponds to an example of the use history of the customer.

The timing at which the purchase date is extracted from the purchase history file 2174 is not particularly limited. For example, the purchase date may be extracted once a day after the store is closed. In some examples, each time the purchase history file 2174 is updated, the purchase date may be extracted for the customer (the customer code) to be updated.

### THIRD MODIFICATION

In an embodiment, the customer terminal 10 identifies the updated merchandise, but the embodiments are not limited thereto. For example, the server device 20 may identify the updated merchandise. In this case, the server device 20 functions as an example of an information processing device.

When implementing this modification, the server device implements the above-described updated merchandise identification unit 103 as a functional unit, so that effects same as those of the above-described embodiment can be achieved. Specifically, the updated merchandise identification unit 103 of the server device 20 identifies the updated merchandise related to the customer based on a customer code of a customer whose entry state is “entered” and generates the updated merchandise information. Then, the information providing unit 202 of the server device 20 provides the updated merchandise information generated by the updated merchandise identification unit 103 to the customer terminal 10 associated with the customer code whose entry state is “entered”. Accordingly, in the customer terminal 10, the display control unit 104 can display the above-described purchase support screen.

### FOURTH MODIFICATION

In an embodiment, the favorite area of the customer is derived from the purchase history of the customer. However, a method of deriving the favorite area is not limited thereto. For example, if the purchase support system 1 has a configuration capable of tracking the behavior of the customer (or the customer terminal 10) who moves inside the store, the analysis unit 203 may derive the area frequently used by the customer based on a staying (dwell) time of the customer terminal 10 in each area.

The configuration for tracking the behavior of the customer is not particularly limited. For example, any known technique such as a monitoring camera system can be used. For example, by using a beacon terminal provided in each area, the staying time for each area may be acquired from a communication time between the beacon terminal and the customer terminal 10.

Accordingly, when the customer does not frequently purchase the merchandise from an area but frequently visits the area, the area can be set as the favorite area. For example, an area in which expensive merchandise is arranged, but from which the customer rarely buys can be revealed as a favorite area.

### FIFTH MODIFICATION

In an embodiment, the information based on the updated merchandise information is displayed and output on the display unit 114, but an output method is not limited thereto. For example, the display control unit 104 of the customer terminal 10 or a separate output control unit may output the updated merchandise information or the information based on the updated merchandise information to a printer or transmit the updated merchandise information (or the information based on the updated merchandise information) to an external device through the communication unit 117 or the like.

Programs executed by the respective devices according to an embodiment described above can be incorporated in a ROM, a storage unit, or the like in advance. The programs executed by the respective devices according to the embodiment described above may be provided by being recorded in a non-transitory, computer-readable recording medium such as a CD-ROM, a flexible disk (FD), a CD-R, or a digital versatile disk (DVD) in an installable or executable form of a file.

Further, the programs executed by the respective devices according to the above-described embodiments may also be stored in a computer connected to a network such as the Internet and provided by being downloaded via the network. The programs executed by the respective devices according to the above-described embodiments may also be accessed or distributed via a network such as the Internet.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An information processing device, comprising:
an extraction unit configured to extract a previous visit date from a use history of a customer who visits a store;
an identification unit configured to identify, based on relationship information indicating a temporal relationship between a plurality of areas for arranging products provided in the store and sales modes of the products arranged in the areas, the area in which the merchandise whose sales mode is changed from the previous visit date to a current visit date is arranged; and
an output unit configured to output information indicating the area identified by the identification unit.

2. The information processing device according to claim 1, wherein the identification unit is configured to identify, based on the relationship information indicating a temporal relationship between each of the areas and the products arranged in the area, the area in which the merchandise whose arrangement position is changed from the previous visit date to the current visit date is arranged.

3. The information processing device according to claim 1, wherein the identification unit is configured to identify, based on the relationship information indicating a temporal relationship between each of the areas and a price of the merchandise arranged in the area, the area in which the merchandise whose price is changed from the previous visit date to the current visit date is arranged.

4. The information processing device according to claim 1, wherein the identification unit is configured to identify, from among the products arranged in a part of the plurality of areas, the merchandise whose sales mode is changed from the previous visit date to the current visit date.

5. The information processing device according to claim 1, wherein the output unit is configured to output, to a display unit, a screen on which the area identified by the identification unit is identifiable on a map indicating a layout of the store.

6. An information processing method, comprising:
extracting a previous visit date from a use history of a customer who visits a store;
identifying, based on relationship information indicating a temporal relationship between a plurality of areas for arranging products provided in the store and sales modes of the products arranged in the areas, the area in which the merchandise whose sales mode is changed from the previous visit date to a current visit date is arranged; and
outputting information indicating the identified arrangement area.

7. A shopping support system, comprising:
a store server storing:
a merchandise master including a list of items for sale at a store,
an arrangement variation file providing an store placement history for items for sale at the store,
a customer master including a list of customers who have previously shopped at the store, and
a purchase history file including a list of items purchased by customers in the customer master on a previous visit to the stores; and
a customer terminal connectable to the store server and including:
a display screen for displaying information to a customer; and
a control unit configured to:
receive customer information from the store server upon entry to the store, and
display a purchase support screen on the display screen based on the received customer information, the purchase support screen indicating particular items located in a predetermined area of the store that have either had a change in price or have been added to the predetermined area since the customer's previous visit.

8. The shopping support system according to claim 7, wherein the predetermined area is set based on the number of items purchased by the customer from the predetermined area in previous visits.

9. The shopping support system according to claim 7, wherein the predetermined area is set by the customer in advance.

10. The shopping support system according to claim 7, wherein the purchase support screen is based on a store map provided by the store server.

11. The shopping support system according to claim 7, wherein the customer terminal is a smartphone.

12. The shopping support system according to claim 7, wherein the customer terminal is a shopping cart-mounted tablet terminal.

13. The shopping support system according to claim 7, wherein the store server is configured to detect an entry of the customer to the store.

14. The shopping support system according to claim 13, wherein the store server detects the entry of the customer to the store based on a login operation performed via the customer terminal.

15. The shopping support system according to claim 13, wherein the store server detects the entry of the customer to the store based on a login operation performed via connection of the customer terminal to a store network.

16. The shopping support system according to claim 7, wherein the particular items have been added to the predetermined area since the previous visit.

17. The shopping support system according to claim 7, wherein the particular items are reduced in price since the previous visit.

18. The shopping support system according to claim 7, wherein customer terminal further includes:
a camera for imaging items of merchandise to obtain a commodity code of the items.

19. The shopping support system according to claim 7, wherein the store server is configured to detect an exit of the customer from the store based on a logout operation performed via the customer terminal.

20. The shopping support system according to claim 7, wherein the store server is configured to detect an exit of the customer from the store after the customer terminal has been disconnected from a store network for a predetermined length of time.
